(19) United States
(12) Patent Application Publication
(10) Pub. No.: US 2025/0280945 A1
(43) Pub. Date: Sep. 11, 2025

(54) Equipment Holder System

(71) Applicant: Peter Jones (ILG) Limited, Abergavenny Monmouthshire (GB)

(72) Inventor: Owen Jones, Abergavenny (GB)

(21) Appl. No.: 19/070,717

(22) Filed: Mar. 5, 2025

(30) Foreign Application Priority Data
Mar. 6, 2024 (GB) 2403267.4

(51) Int. Cl. A45F 5/02; A45F 5/00; E05B 75/00; F41H 9/10

(52) U.S. Cl. CPC A45F 5/021; A45F 5/1566; E05B 75/005; F41H 9/10

(57) ABSTRACT

An equipment holder system includes a carrier component and a dock component. The carrier component is configured to hold equipment. One of the carrier component and the dock component includes a slide member and the other of the carrier component and the dock component includes a slide channel configured to receive the slide member in order to releasably connect the carrier component to the dock component. The slide channel includes a stop which is configured to engage the slide member when received in the slide channel to prevent withdrawal. The slide member is released from the stop by pushing the carrier component towards the dock component and then sliding the carrier component relative to the dock component.

### CROSS-REFERENCE TO RELATED APPLICATIONS

This application claims priority to GB2403267.4 filed Mar. 6, 2024, the entire disclosure of which is incorporated by reference.

### FIELD

The present disclosure relates to an equipment holder system.

### BACKGROUND

Incapacitant (irritant) sprays, such as PAVA, OC and CS spray, may be used by police officers, prison officers and the like to temporarily incapacitate a violent person who cannot otherwise be restrained.

Such incapacitant sprays are typically dispensed from a handheld canister. In order to provide quick access to the canister, they are typically carried in a holder worn on the person. In particular, the holder may be provided with a belt loop or MOLLE attachment. In order to improve security, the holder may be provided with a retaining strap which must be opened before the spray can be used. However, this may delay use of the spray. Similar holders may also be used for other pieces of equipment, such as handcuffs and batons.

It is desirable to provide an equipment holder system which has improved functionality.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to an aspect, there is provided an equipment holder system comprising: a carrier component configured to hold equipment; and a dock component; wherein one of the carrier component and the dock component comprises a slide member and the other of the carrier component and the dock component comprises a slide channel configured to receive the slide member in order to releasably connect the carrier component to the dock component; wherein the slide channel comprises a stop which is configured to engage the slide member when received in the slide channel to prevent withdrawal and wherein the slide member is released from the stop by pushing the carrier component towards the dock component and then sliding the carrier component relative to the dock component.

A resilient biasing element may bias the carrier component away from the dock component such that the slide member is engaged by the stop.

The resilient biasing element may be arranged such that pushing the carrier component towards the dock component causes to resilient biasing element to resiliently deflect.

The resilient biasing element may be a cantilevered tab.

The stop may be a retaining barb which allows the slide member to be received within the slide channel but prevents withdrawal.

The slide channel and slide member may have complementary T-shaped cross-sections.

The stop may be provided on a rear surface of the slide channel.

The equipment holder system may further comprise a ramp portion which is configured to force a first end of the slide member towards a rear surface of the slide channel.

The stop may be configured to engage with a second end of the slide member.

The slide channel may be formed by a pair of side rails which each comprise an upstand portion and a retaining portion which projects perpendicularly from the upstand portion. The retaining portions may project towards one another but are spaced apart to form a slot therebetween.

The stop is provided adjacent to an entry end of the slide channel.

The slide channel may comprise a lead-in portion for guiding the slide member into the slide channel.

The dock component may comprise a belt attachment interface.

The carrier component is configured to hold an incapacitant spray canister, a pair of handcuffs or a baton.

The carrier component comprises a pot portion which may be configured to receive an incapacitant spray canister.

The pot portion may comprise a pair of retaining tabs which are configured to hold the incapacitant spray canister in the pot portion.

The dock component may comprise a sensor housing configured to hold a sensor for detecting the presence of the equipment when the carrier component is docked with the dock component.

The carrier component may comprise a sensor window which faces the sensor housing when the carrier component is docked with the dock component.

According to another aspect, there is provided a dock component for an equipment holder system as described above. The dock component may have any of the features described above in relation to the equipment holder system.

According to an aspect, there is provided an equipment holder system comprising: a carrier component configured to hold equipment; and a dock component; wherein the carrier component is releasably connectable to the dock component; wherein the dock component comprises a sensor housing configured to hold a sensor for detecting the presence of the equipment when the carrier component is docked with the dock component.

The carrier component may comprise a sensor window which faces the sensor housing when the carrier component is docked with the dock component.

The carrier component may comprise a pot portion which is configured to receive an incapacitant spray canister. The pot portion may comprise an indent which forms a step that projects radially inward towards the sensor window. The indent may be configured to force the spray canister towards the sensor window.

The equipment holder system may further comprise the sensor disposed within the sensor housing.

The sensor may be an inductive proximity sensor.

The sensor may be configured to be paired to a body-warn camera. The sensor may provide a trigger signal which automatically activates the body-worn camera when the carrier component is undocked.

One of the carrier component and the dock component may comprise a slide member and the other of the carrier component and the dock component may comprise a slide channel configured to receive the slide member in order to releasably connect the carrier component to the dock component.

The slide channel may comprise a stop which is configured to engage the slide member when received in the slide channel to prevent withdrawal and the slide member may be released from the stop by pushing the carrier component towards the dock component and then sliding the carrier component relative to the dock component.

The skilled person will appreciate that except where mutually exclusive, a feature described in relation to any one of the above aspects may be applied mutatis mutandis to any other aspect. Furthermore, except where mutually exclusive, any feature described herein may be applied to any aspect and/or combined with any other feature described herein.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

Embodiments will now be described by way of example only, with reference to the Figures, in which:

FIG. 1 is a perspective view of an example incapacitant spray holder system according to the present disclosure;

FIG. 2 is a rear perspective view of a carrier component of the holder system;

FIG. 3 is a rear view of the carrier component;

FIG. 4 is a top view of the carrier component;

FIG. 5 is a bottom view of the carrier component

FIG. 6 is a side view of the carrier component;

FIGS. 7 and 8 are cross-sectional views of the carrier component;

FIG. 9 is a front perspective view of dock component of the holder system

FIG. 10 is a rear perspective view of the dock component;

FIG. 11 is a front view of the dock component;

FIGS. 12 and 13 are cross-sectional views of the dock component;

FIGS. 14 to 19 show the holder system at different stages of an engagement action; and

FIGS. 20 to 23 show the holder system at different stages of a disengagement action.

In the drawings, reference numbers may be reused to identify similar and/or identical elements.

### DETAILED DESCRIPTION

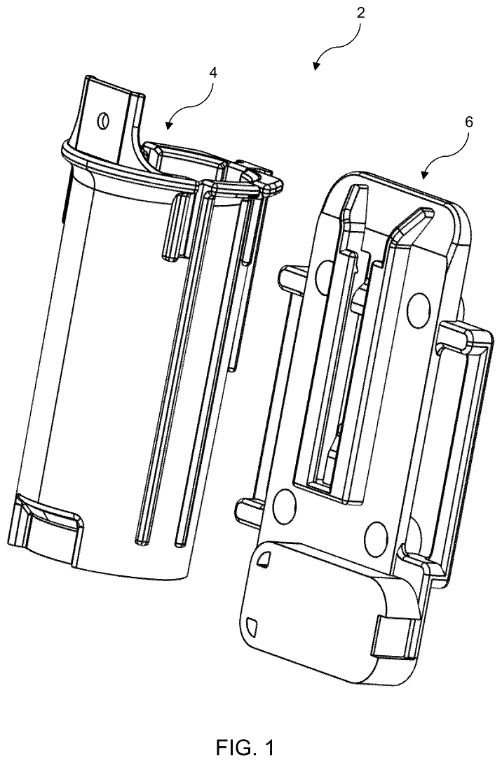

FIG. 1 shows an example incapacitant spray holder system 2 according to the present disclosure. The spray holder system 2 comprises a spray carrier component 4 and a dock component 6. As will be described in detail below, the carrier component 4 is releasably connectable to the dock component 6 to allow engagement and disengagement.

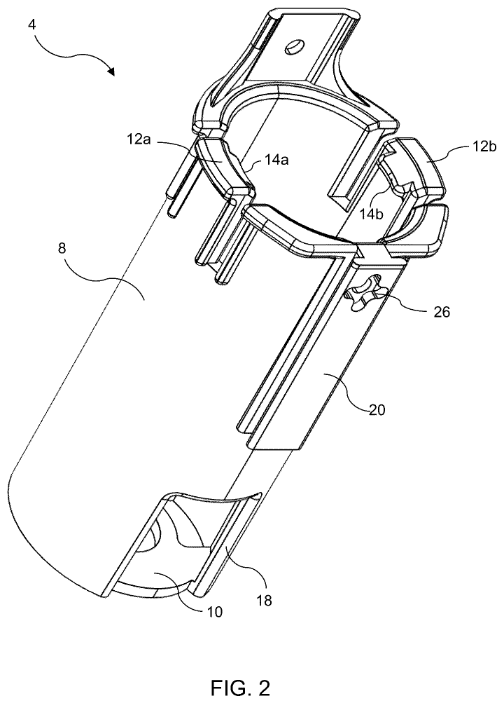

As shown in FIG. 2, the carrier component 4 comprises a pot portion 8 for receiving a spray canister. The pot portion 8 is generally cylindrical and is open at a first end and is provided with a base wall 10 at a second end.

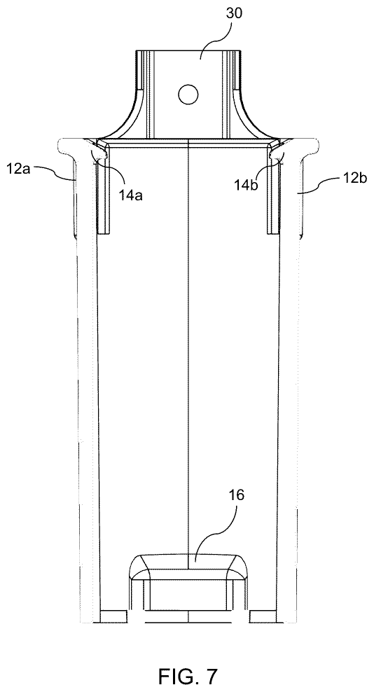

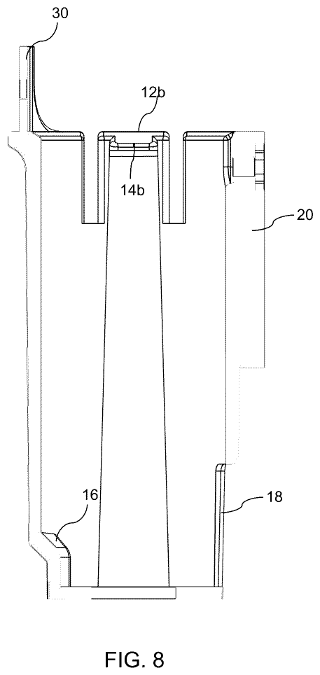

A pair of retaining tabs 12a, 12b are formed in the pot portion 8. The retaining tabs 12a, 12b are cantilevered and are each provided with a barb 14a, 14b at a distal end. The barbs 14a, 14b project inwardly towards one another (i.e., towards a longitudinal axis of the pot portion 8). Each barb 14a, 14b has a directional geometry. Specifically, each barb 14a, 14b has an inclined upper surface and a radial lower surface, as can be best seen in FIG. 7. The inclined upper surface extends in a direction which has a radial and an axial component and slopes downwards (towards the second end of the pot portion 8 when moving towards the longitudinal axis of the pot portion 8).

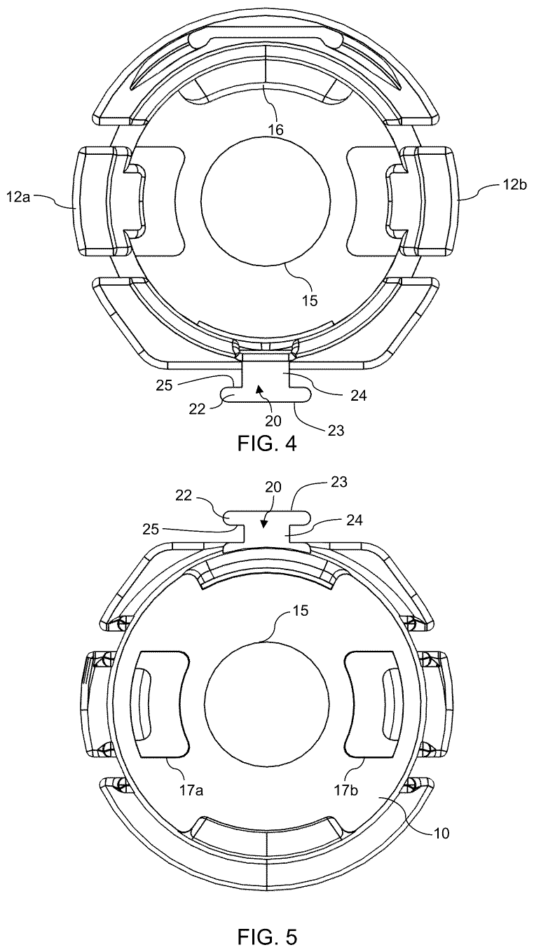

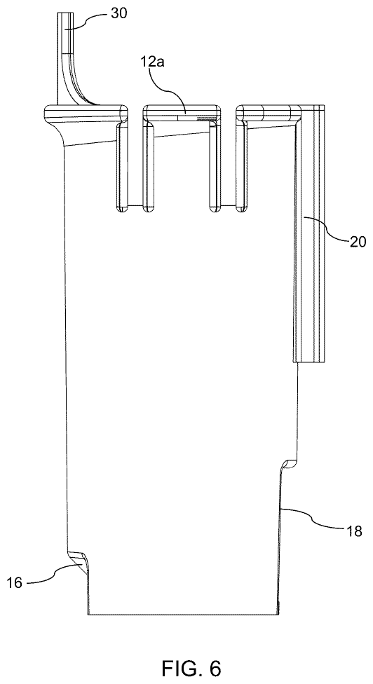

The pot portion 8 comprises an indent 16. The indent 16 is located at the second end of the pot portion 8 and forms a step which projects radially inward, as shown in FIG. 4. An opening is provided in the pot portion 8 which forms a sensor window 18. The sensor window 18 is diametrically opposed from the indent 16.

The pot portion 8 is sized to receive a spray canister, with a head portion (nozzle) of the spray canister projecting above the pot portion 8. When inserting the spray canister into the pot portion 8, the inclined upper surface of the barbs 14a, 14b ride over the end of the spray canister, causing the retaining tabs 12a, 12b to resiliently deflect radially outwards. Once inserted, the barbs 14a, 14b retain the spray canister in the pot portion 8. The spray canister may be released from the pot portion 8 by pushing the spray canister upwards through a circular hole 15 (although, in other examples, it may have another shape) formed in the base wall 10

Spray canisters may be supplied in a variety of sizes. For example, spray canisters having a diameter of 35 mm or 38 mm are commonly used. Spray canisters with a larger diameter (i.e., those with a diameter of 38 mm) are typically shorter than those with a smaller diameter (i.e., those with a diameter of 35 mm). Accordingly, a larger diameter spray canister may not extend to the bottom of the pot portion 8 and may be supported on or above the indent 16. On the other hand, a smaller diameter spray canister may extend past the indent 16 and to (or towards) the bottom of the pot portion 8. The indent 16 is configured to force the smaller diameter spray canister towards the sensor window 18, as will be described further below.

The carrier component 4 further comprises a slide member 20. The slide member 20 extends longitudinally along the pot portion 8 from the first end towards the second end. As can be seen in FIGS. 4 and 5, the slide member 20 has a T-shaped cross-section formed by a head portion 22 which is spaced from the pot portion 8 by a neck portion 24. The head portion 22 is wider than the neck portion 24. The head portion 22 defines an outer surface 23 facing away from the pot portion 8 and a pair of inner shoulders 25 facing towards the pot portion and on either side of the neck portion 24.

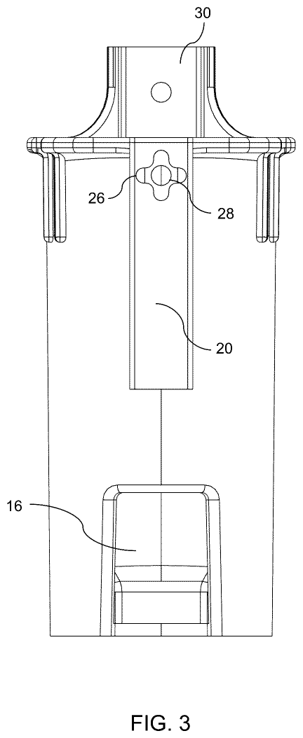

A non-circular recess 26 is formed in the outer surface of the head portion 22 of the slide member 20. In this example, the recess 26 has a cruciform profile formed by four lobes, as best seen in FIG. 3. A bore 28 is located at the center of the recess 26 which is configured to receive a threaded insert. The recess 26 is configured to receive a head component of a connector stud, such as that described in UK Patent No. GB2575650 (or any other Klick Fast™ connector stud), which is connected to the carrier component 4 by passing a screw through the head component and into the threaded insert. The connector stud may be used to connect the carrier component 4 to an alternative connector dock and not the dock component 6.

A press-stud tab 30 projects from the first end of the pot portion 8. The press-stud tab 30 may be required when the carrier component 4 is used with an alternative connector dock and not the dock component 6. In particular, a first part of a press stud may be affixed to the press-stud tab 30 for mating with a complementary second part of the press stud provided on a retaining strap of the alternative connector dock. The retaining strap must be released from the carrier component 4 before the carrier component 4 can be removed from the alternative connector dock and the spray canister can be used. However, a retaining strap is not required for the dock component 6, as will be described below.

The base wall 10 further comprises a pair of lanyard holes 17a, 17b which may be used to attach a first end of a lanyard to the carrier component 4. The lanyard holes 17a, 17b are located on either side of the circular hole 15. The lanyard may be tied to the base wall 10 by passing the lanyard through one of the lanyard holes 17a, 17b and looping the lanyard back through one circular hole 15.

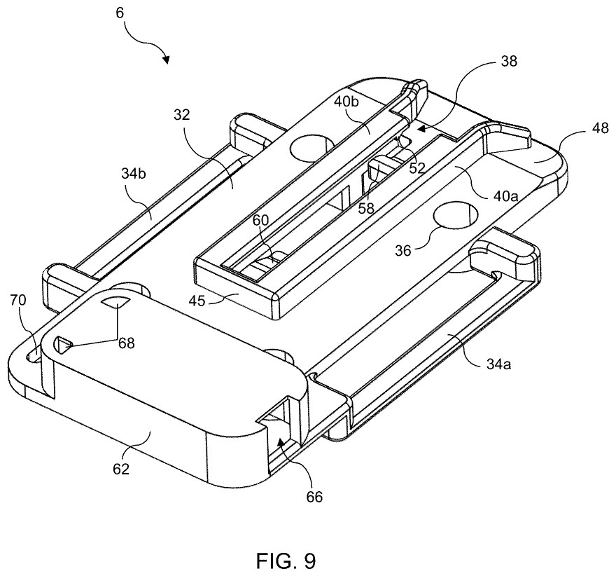

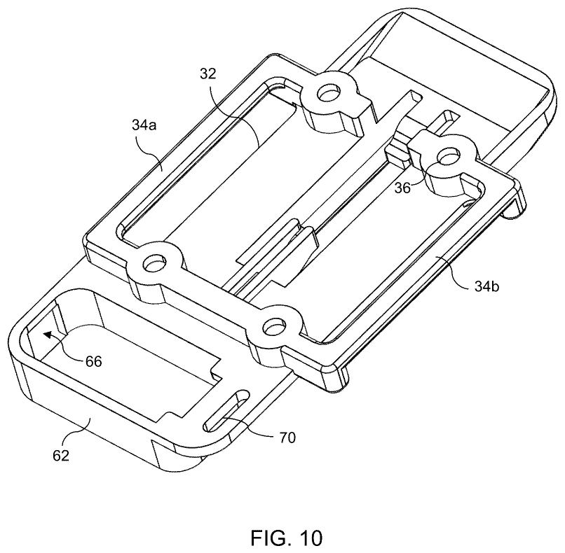

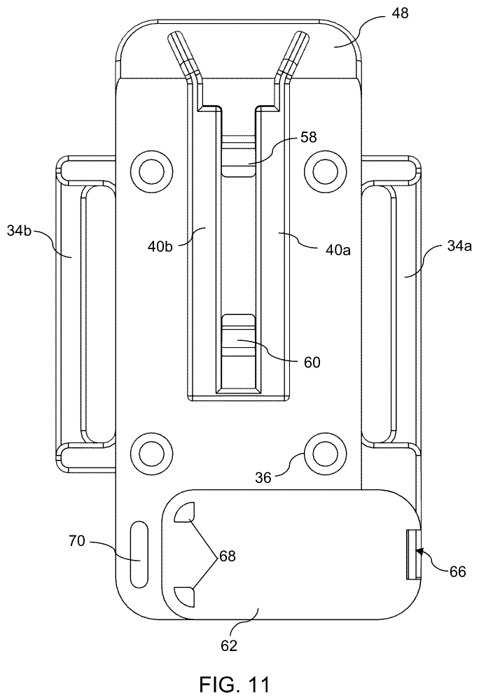

The dock component 6 will now be described with reference first to FIGS. 9 and 10. As shown, the dock component 6 comprises a base plate 32. First and second belt posts 34a, 34b are provided on either side of the base plate 32. The first and second belt posts 34a, 34b are offset from the plane of the base plate 32 and form a slot for receiving a belt which passes around a rear surface of the base plate 32. It will be appreciated that other forms belt attachment interface may be used.

The base plate 32 is further provided with four holes 36 which may be used to attach the base plate 32 to a backing panel with alternative means for attaching to a person. For example, the backing panel may comprise a MOLLE attachment or Klick Fast™ connector stud. The backing panel may also incorporate a rotary indexing mechanism which allows the base plate 32 to be rotated to discrete rotary positions.

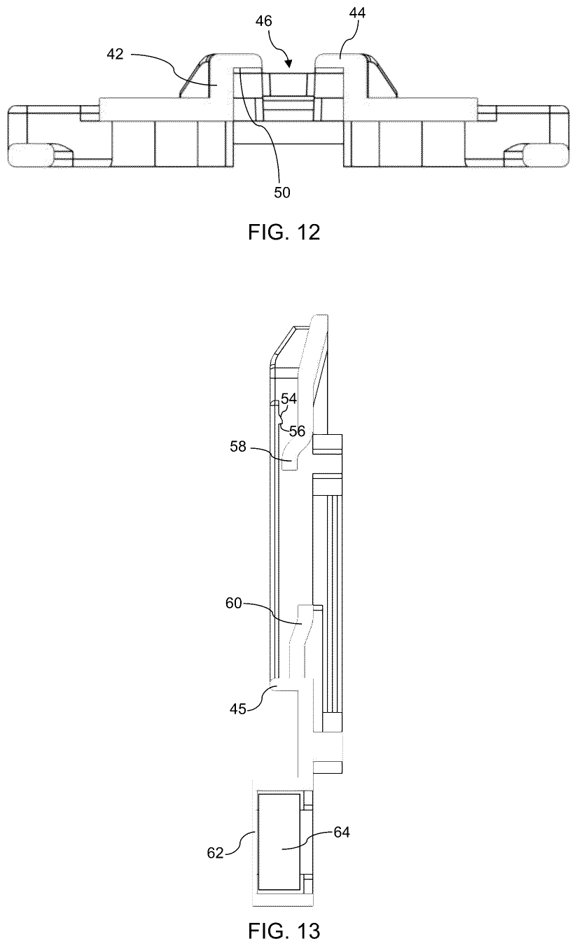

A slide channel 38 is provided on the base plate 32 for receiving the slide member 20 of the carrier component 4. The slide channel 38 is formed by a pair of side rails 40a, 40b. As best seen in FIG. 12, each side rail 40a, 40b comprises an upstand portion 42 and a retaining portion 44. The upstand portion 42 projects upwards from the base plate 32 running parallel to one another and the retaining portion 44 projects perpendicularly from the upstand portion 42 such that the retaining portion 44 is spaced from but parallel to the plane of the base plate 32. The side rails 40a, 40b are arranged such that their respective retaining portions 44 project towards one another but are spaced apart to form a slot 46 therebetween. The slide channel 38 thus has a substantially T-shaped cross-section which is sized to receive the slide member 20, as will be described further below.

As shown, at an entry end of the slide channel 38, the upstand portions 42 extend to form a lead-in section to the slide channel 38. The upstand portions 42 taper towards one another over the lead-in section so as to guide the slide member 20 into the slide channel 38. The base plate 32 also has a sloped portion 48 which acts to guide the slide member 20 into the plane of the slide channel 38. The slide channel 38 is closed at the opposite end to the lead-in section by an end wall 45 which connects the side rails 40a, 40b to one another.

A rear surface 50 of the retaining portions 44 each comprise a retaining barb 52. The retaining barbs 52 each have a directional geometry with an inclined outer surface 54 and an upright inner surface 56, as best shown in FIG. 13. The retaining barbs 52 are located at or towards the entry end of the slide channel 38.

The base plate 32 further comprises a cantilevered tab 58 and a ramp portion 60. The cantilevered tab 58 and ramp portion 60 are disposed between the rails 40a, 40b. The cantilevered tab 58 is located adjacent to the entry to the slide channel 38 and the ramp portion 60 located adjacent the end wall 45 and so is spaced along the slide channel 38 from the cantilevered tab 58. As best shown in FIG. 13, the cantilevered tab 58 projects upwards from the plane of the base plate 32 and forms a resilient biasing element. The ramp portion 60 is a rigid element which slopes upwards from the plane of the base plate 32 as it approaches the end wall 45.

A lower portion of the base plate 32 is provided with a sensor housing 62 for receiving a sensor 64 (shown schematically in FIG. 13), such as an inductive proximity sensor. The sensor housing 62 has an opening 66 which provides access to a charging port of the sensor 64. Two further openings 68 are provided for viewing indicator lights of the sensor 64.

The base plate 32 is further provided with a lanyard hole 70. In this example, the lanyard hole 70 is adjacent to the sensor housing 62, although in other examples it may be located elsewhere. The lanyard hole 70 can be used to attach a second of the lanyard to the dock component 6 so that the carrier component 4 and spray canister is tethered to the dock component 6.

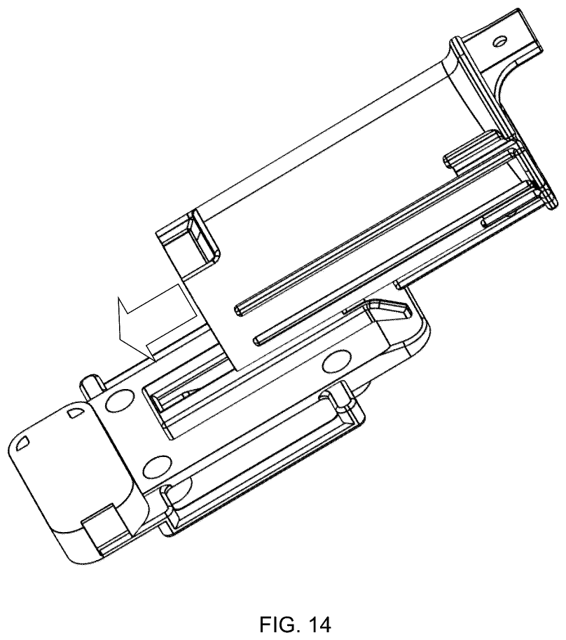

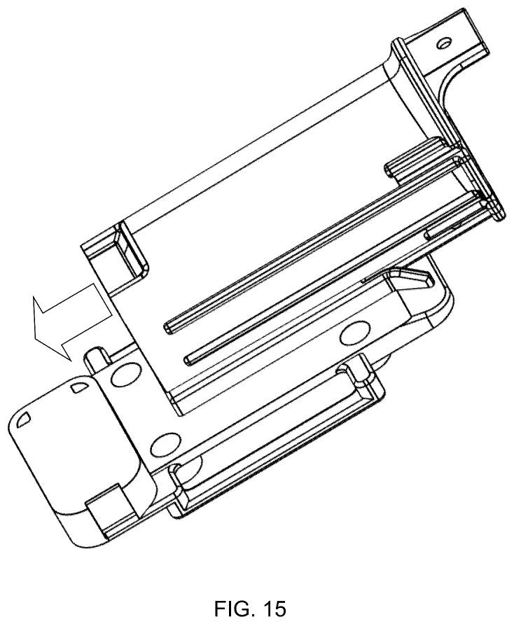

As shown in FIG. 14, the carrier component 4 may be engaged with the dock component 6 by translating the carrier component 4 relative to the dock component 6 such that the slide member 20 enters the slide channel 38. As described previously, the sloped portion 48 and lead-in section act to guide the slide member 20 into the slide channel 38.

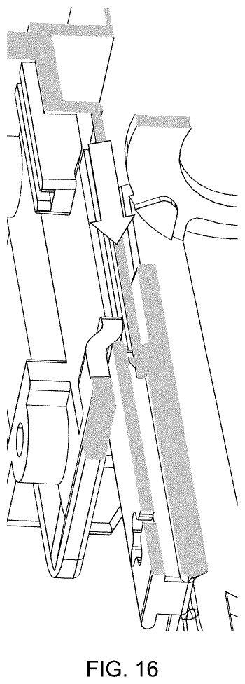

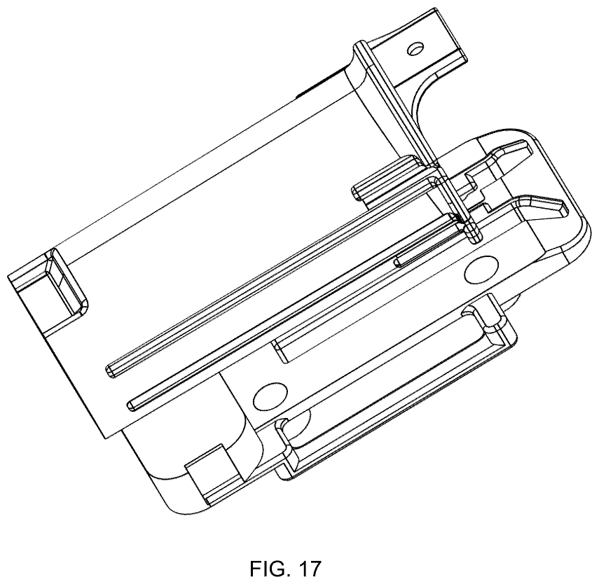

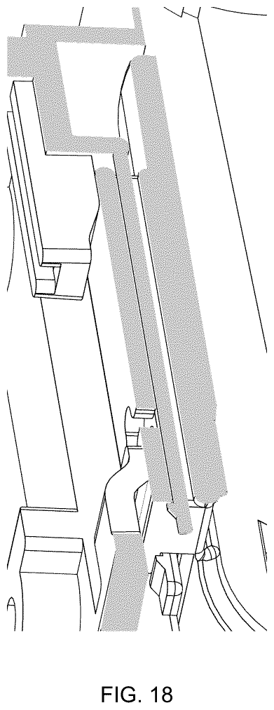

As shown in FIGS. 15 and 16, as the slide member 20 enters the slide channel 38, the inner shoulders 25 of the head portion 22 ride over the inclined outer surfaces 54 of the retaining barbs 52. A first end of the head portion 22 of the slide member 20 is brought into contact with the cantilevered tab 58 and the further translation of the slide member 20 along the slide channel 38 causes the cantilevered tab 58 to be resiliently deflected towards the plane of the base plate 32. The outer surface 23 of the head portion 22 rides over the cantilevered tab 58 until the head portion 22 clears the retaining barbs 52. In this position, the cantilevered tab 58 biases the inner shoulders 25 of the head portion 22 towards and against the rear surface 50 of each retaining portion 44, as shown in FIG. 18. The second end of the head portion 22 engages the upright inner surfaces 56 of the retaining barbs 52 and thus this prevents withdrawal of the slide member 20 from the slide channel 38 and therefore undocking of the carrier component 4 from the dock component. As shown, the first end of the head portion 22 and the outer surface 23 also ride over the ramp portion 60 as the slide member 20 translates along the slide channel 38. The ramp portion 60 causes the first end of the head portion 22 to be forced towards the rear surface 50 of each retaining portions 44. The inner shoulders 25 of the head portion 22 therefore lie against the rear surfaces 50 of the retaining portions 44 along its length and thus the slide member 20 is held parallel within the slide channel 38.

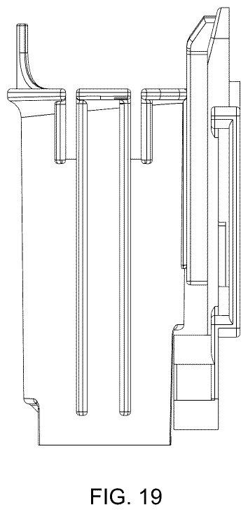

As shown in FIG. 19, in this engaged position, the sensor window 18 of the carrier component 4 is held against the sensor housing 62 of the dock component 6. The spray canister within the carrier component 4 is thus held close to the sensor 64 located within the sensor housing 62.

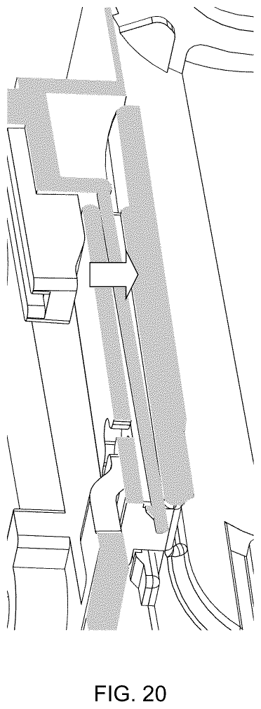

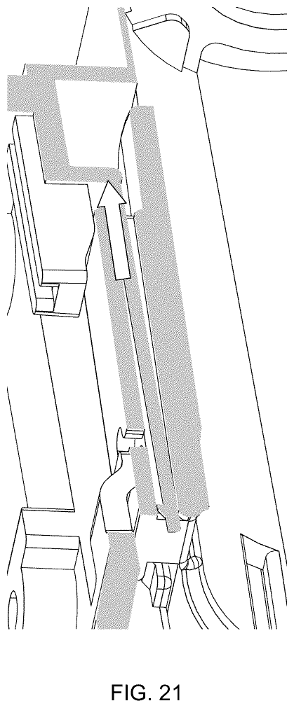

In order to release the carrier component 4 from the dock component 6, the carrier component 4 must first be pushed towards the dock component 6, as shown in FIG. 20. This causes the inner shoulders 25 of the head portion 22 to move away from the rear surfaces 50 of the retaining portions 44 such that the second end of the head portion 22 clears the upright inner surfaces 56 of the retaining barbs 52. As described previously, the first end of the head portion 22 is supported by the ramp portion 60 in this position. Accordingly, pushing the carrier component 4 towards the dock component 6 causes a slight rotation of the slide member 20 within the slide channel 38. This ensures that the pushing force acts to raise the second end of the head portion 22 above the upright inner surfaces 56 of the retaining barbs 52 and so provides a more intuitive and reliable release of the carrier component 4.

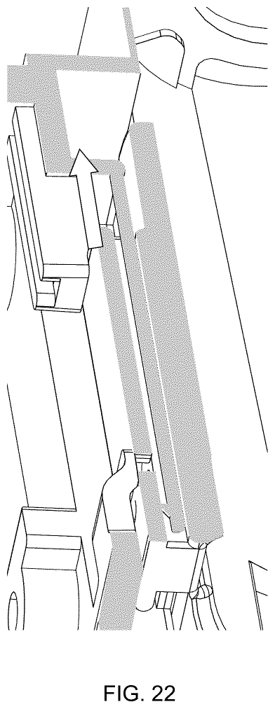

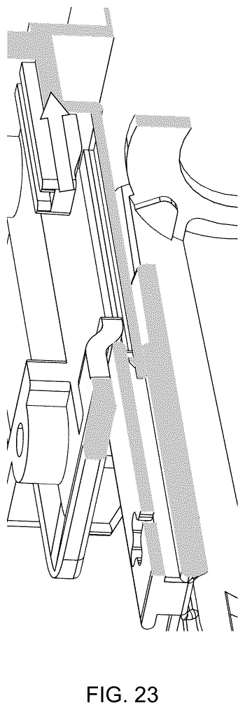

As shown in FIGS. 22 and 23, the carrier component 4 can then be translated relative to the dock component 6 in order to slide the slide member 20 along and out of the slide channel 38 in order to release the carrier component 4 from the dock component 6.

It will be appreciated that the upstand portions 42, retaining barbs 52 and the head portion 22 must be sized relative to one another to provide sufficient headroom for the head portion 22 to be allowed to clear the retaining barbs 52.

The undocking of the carrier component 4 from the dock component 6 moves the spray canister away from the sensor 64. As described previously, the sensor 64 is an inductive proximity sensor which is configured to detect the presence of the spray canister. The sensor 64 may be paired to a body-worn camera via a wireless interface (such as Bluetooth®). When the sensor 64 detects the spray canister being undocked, the sensor 64 provides a trigger signal which automatically activates the body-worn camera in order to record the subsequent events (e.g., use of the spray canister). Alternatively, or in addition, the trigger signal may provide an alert or other communication to a dispatch center or the like.

As described previously, the indent 16 in the pot portion 8 is configured to force a smaller diameter spray canister towards the sensor window 18 and thus allows accurate and reliable detection of the spray canister (and triggering of the body-worn camera) using the sensor 64.

The holder system 2 utilizes a push and slide action to release the carrier component 4 from the dock component 6. This allows the carrier component 4 (and the equipment therewithin) to be quickly and reliably undocked and used. In particular, this action can be performed with one hand and in a single fluid movement. Nevertheless, the push and slide action reduces the potential for unauthorized removal of the carrier component 4 by third parties who are unaware of the need to, or unable to apply, the required pushing force before sliding the carrier component 4. This is achieved without needing an additional retaining strap which can delay access.

It will be appreciated that the dock component 6 may be used with alternative carrier components adapted for carrying other equipment (as part of an equipment holder system), such as a pair of handcuffs or a baton. Such carrier components may be provided with a corresponding sensor window to allow the sensor 64 to detect the undocking of the equipment within the carrier component 4 and the automatic activation of a body-worn camera. The sensor window may be appropriately located to expose a metal portion of the equipment to the sensor 64. In other examples, the sensor window may be formed as a thinned section of the carrier component which allows a reliable detection of the docking and undocking of the equipment. In other examples, the carrier component may not need a sensor window (e.g., if the carrier component is sufficiently thin that the equipment can be detected or if the equipment is exposed in some other way by the carrier component in the position where the sensor housing of the dock is located). The arrangement of the sensor housing on the dock component in conjunction with a removable carrier component may be beneficial without the interconnection mechanism described above. For example, the carrier component and dock component may interface through a simple slide connection which does not require a push and slide action.

It will be appreciated that the retaining barbs 52 may differ from those described above whilst still performing the function of preventing withdrawal of the carrier component. For example, the slide channel 38 may utilize one or more stops (protrusions) on the retaining portions 44 instead of barbs (i.e., which do not have directional geometry). The slide member 20 may instead include an inclined or rounded surface at its first end such that it rides over the stop when being inserted into the slide channel 38. The or each stop may also be positioned partway along the length of the slide channel 38 and configured to engage with a complementary recess formed in the slide member 20 and positioned appropriately to align with the stop when the slide member 20 is fully inserted into slide channel 38.

Further, other forms of resilient biasing element may be used instead of the cantilevered tab 58.

The dock component 6 may be used with existing carrier components having suitable slide members in order to retrofit the system.

In other examples, the slide member may be provided on the dock component 6 and the slide channel may be provided on the carrier component 4.

Although the slide member 20 and slide channel 38 have been described as having T-shaped cross-sections, it will be appreciated that this encompasses head portions of various shapes provided on a narrower neck portion.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. An equipment holder system comprising:
a carrier component configured to hold equipment; and
a dock component, wherein:
one of the carrier component and the dock component includes a slide member, and the other of the carrier component and the dock component includes a slide channel configured to receive the slide member in order to releasably connect the carrier component to the dock component,
the slide channel includes a stop configured to engage the slide member when received in the slide channel to prevent withdrawal, and
the slide member is configured to be released from the stop by pushing the carrier component towards the dock component and then sliding the carrier component relative to the dock component.

2. The equipment holder system of claim 1, wherein a resilient biasing element biases the carrier component away from the dock component such that the slide member is engaged by the stop.

3. The equipment holder system of claim 2, wherein the resilient biasing element is arranged such that pushing the carrier component towards the dock component causes the resilient biasing element to resiliently deflect.

4. The equipment holder system of claim 2, wherein the resilient biasing element is a cantilevered tab.

5. The equipment holder system of claim 1, wherein the stop is a retaining barb which allows the slide member to be received within the slide channel but prevents withdrawal.

6. The equipment holder system of claim 1, wherein the slide channel and slide member have complementary T-shaped cross-sections.

7. The equipment holder system of claim 1, wherein the stop is provided on a rear surface of the slide channel.

8. The equipment holder system of claim 1, further comprising a ramp portion which is configured to force a first end of the slide member towards a rear surface of the slide channel.

9. The equipment holder system of claim 1, wherein the stop is configured to engage with a second end of the slide member.

10. The equipment holder system of claim 1, wherein:
the slide channel is formed by a pair of side rails which each include an upstand portion and a retaining portion which projects perpendicularly from the upstand portion,
the retaining portions project towards one another but are spaced apart to form a slot therebetween.

11. The equipment holder system of claim 1, wherein the stop is provided adjacent to an entry end of the slide channel.

12. The equipment holder system of claim 1, wherein the slide channel includes a lead-in portion configured to guide the slide member into the slide channel.

13. The equipment holder system of claim 1, wherein the dock component includes a belt attachment interface.

14. The equipment holder system of claim 1, wherein the carrier component is configured to hold an incapacitant spray canister, a pair of handcuffs or a baton.

15. The equipment holder system of claim 1, wherein the carrier component includes a pot portion which is configured to receive an incapacitant spray canister.

16. The equipment holder system of claim 15, wherein the pot portion includes a pair of retaining tabs which are configured to hold the incapacitant spray canister in the pot portion.

17. The equipment holder system of claim 1, wherein the dock component includes a sensor housing configured to hold a sensor configured to detect the presence of the equipment when the carrier component is docked with the dock component.

18. The equipment holder system of claim 17, wherein the carrier component includes a sensor window which faces the sensor housing when the carrier component is docked with the dock component.

19. A dock component for the equipment holder system of claim 1.

20. An equipment holder system comprising:
a carrier component configured to hold equipment; and
a dock component, wherein:
the carrier component is releasably connectable to the dock component, and
the dock component includes a sensor housing configured to hold a sensor configured to detect the presence of the equipment when the carrier component is docked with the dock component.

21. The equipment holder system of claim 20, wherein the carrier component includes a sensor window which faces the sensor housing when the carrier component is docked with the dock component.

22. The equipment holder system of claim 21, wherein:
the carrier component includes a pot portion which is configured to receive an incapacitant spray canister,
the pot portion includes an indent which forms a step that projects radially inward towards the sensor window, and
the indent is configured to force the spray canister towards the sensor window.

23. The equipment holder system of claim 20, further comprising the sensor disposed within the sensor housing.

24. The equipment holder system of claim 23, wherein the sensor is an inductive proximity sensor.

25. The equipment holder system of claim 23, wherein:
the sensor is configured to be paired to a body-worn camera, and
the sensor provides a trigger signal which automatically activates the body-worn camera when the carrier component is undocked.

26. The equipment holder system of claim 20, wherein one of the carrier component and the dock component include a slide member, and the other of the carrier component and the dock component includes a slide channel configured to receive the slide member in order to releasably connect the carrier component to the dock component.

27. The equipment holder system of claim 26, wherein the slide channel includes a stop which is configured to engage the slide member when received in the slide channel to prevent withdrawal, and wherein the slide member is released from the stop by pushing the carrier component towards the dock component and then sliding the carrier component relative to the dock component.
